(19) United States
(12) Patent Application Publication
(10) Pub. No.: US 2003/0010285 A1
(43) Pub. Date: Jan. 16, 2003

(54) Assembly for distributing solid particles on a moving web

(76) Inventors: Robert R. Krebs, Georgetown, TX (US); Ernest L. Phelps, Waco, TX (US); Michael E. Ingrim, Belton, TX (US); Timothy J. Lay, Belton, TX (US); Jay P. O'Brien, Troy, TX (US); Gregory S. Reynolds, Temple, TX (US); Steven C. Dowell, Moody, TX (US); Cory S. Hargrove, Temple, TX (US); Edwin R. Massar JR., Belton, TX (US); Bruce A. Clark, Temple, TX (US); Wilton T. Catoe, Temple, TX (US)

Correspondence Address: WILSONART INTERNATIONAL INC, C/O WELSH & FLAXMAN, LLC, 2341 JEFFERSON DAVIS HIGHWAY, SUITE 112, ARLINGTON, VA, 22202, US

(21) Appl. No.: 09/858,609

(22) Filed: May 15, 2001

(51) Int. Cl. B05C 5/00

(52) U.S. Cl. 118/308

(57) ABSTRACT

The assembly includes a moving web drawn in a first direction and a spreading apparatus evenly distributing solid particles onto the moving web. The spreading apparatus includes a rotating disk having an upper surface and a lower surface. The upper surface is adapted to distribute solid particles outwardly as the solid particles strike the upper surface of the rotating disk. The spreading apparatus further includes a baffle positioned about the rotating disk. The baffle includes a first diameter and a second diameter wherein the first diameter is smaller than the second diameter, and the first diameter is oriented perpendicular to the first direction in which the web is moving and the second diameter is oriented parallel to the first direction in which the web is moving. The spreading apparatus also includes a feed assembly positioned above the rotating disk so as to provide a predetermined supply of solid particles to the upper surface of the rotating disk.

### BACKGROUND OF THE INVENTION

1. Field of the Invention

The invention relates to a distribution assembly for evenly distributing solid particles on a moving web. More particularly, the invention relates to an assembly for evenly distributing aluminum oxide particles on a moving paper web used in the fabrication of decorative laminates.

2. Description of the Prior Art

Aluminum oxide is commonly applied to the uppermost layer (the overlay layer) of decorative laminates to improve the wear resistance of the resulting decorative laminate. In order to provide the optimal surface for the decorative laminate, the aluminum oxide must be evenly distributed along the paper used in the manufacture of the overlay layer. As those skilled in the art appreciate, the problem of applying the aluminum oxide in an efficient, consistent and cost effective manner is consistently confronted by those responsible for ensuring the proper application of the aluminum oxide to the overlay layer.

For example, U.S. Pat. No. 3,014,812 to Sallie discloses a method and apparatus for spreading particles. In accordance with the disclosed invention, a rotating conical impeller 24 distributes particles in a penumbra 36 to coat a substrate moving therebeneath. The particles are spread in a substantially circular pattern and the system uses no overhead structures for controlling the distribution of the flung particles. As a result, it is likely that true uniform distribution of the particles is not achieved and substantial particles are wasted when flung beyond the width of the substrate moving therebeneath (see FIG. 3 of the '812 patent).

U.S. Pat. No. 3,650,243 to Brehm also discloses a rotating device adapted for applying small amounts of a powdery material onto a surface moving therebeneath. As with the patent to Sallie, Brehm's device utilizes no baffle structure for controlling the distribution of powdery material onto the surface moving therebeneath. The lack of any structure for controlling the distribution of particles results in a system failing to ensure the uniform distribution of particles in an efficient and cost effective manner.

Further to the patents of Brehm and Sallie discussed above, U.S. Pat. No. 3,664,297 to Donalies and U.S. Pat. No. 4,743,456 to Spadafora et al. disclose centrifugal apparatuses for the distribution of developer onto an image. As with the prior devices, Donalies and Spadafora et al. fail to provide a system which uniformly coats a moving web in a convenient, reliable and efficient manner.

U.S. Pat. No. 858,508 to Goldman, U.S. Pat. No. 2,768,928 to Kepple et al., U.S. Pat. No. 3,670,694 to Vogel, U.S. Pat. No. 4,069,791 to Tobias, U.S. Pat. No. 4,243,696 to Toth, U.S. Pat. No. 4,705,702 to Shimada et al., U.S. Pat. No. 4,728,035 to Cruse et al., U.S. Pat. No. 4,798,164 to Marazzi, U.S. Pat. No. 4,940,503 to Lindgren and U.S. Pat. No. 5,612,081 to Orr et al. disclose other coating apparatuses designed to provide a uniform coating upon a moving web. However, and as with the patents previously discussed, these prior art devices are highly limited in their ability to uniformly distribute particles upon a moving web in a controlled and efficient manner.

Each of these solutions is replete with problems, resulting in the application of particles in a less than desirable manner. As such, a need exists for a reliable and efficient apparatus capable of evenly distributing solid particles on a moving web. The present invention provides such an apparatus.

### SUMMARY OF THE INVENTION

It is, therefore, an object of the present invention to provide a distribution assembly. The assembly includes a moving web drawn in a first direction and a spreading apparatus evenly distributing solid particles onto the moving web. The spreading apparatus includes a rotating disk having an upper surface and a lower surface. The upper surface is adapted to distribute solid particles outwardly as the solid particles strike the upper surface of the rotating disk. The spreading apparatus further includes a baffle positioned about the rotating disk. The baffle includes a first diameter and a second diameter wherein the first diameter is smaller than the second diameter, and the first diameter is oriented perpendicular to the first direction in which the web is moving and the second diameter is oriented parallel to the first direction in which the web is moving. The spreading apparatus also includes a feed assembly positioned above the rotating disk so as to provide a predetermined supply of solid particles to the upper surface of the rotating disk.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a front view of the distribution assembly in accordance with the present invention.

FIG. 2 is a detailed cross sectional view of the distribution assembly shown in FIG. 1 focusing on the space formed within the baffle.

FIG. 3 is a side view of the distribution assembly shown in FIG. 1.

FIG. 4 is a bottom view showing the baffle and rotating disk.

FIG. 5 is a side view of an alternate feed assembly in accordance with the present invention.

FIG. 6 is a schematic diagramming the grit baffle geometry based upon mathematical considerations.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limited, but merely as the basis for the claims and as a basis for teaching one skilled in the art how to make and/or use the invention.

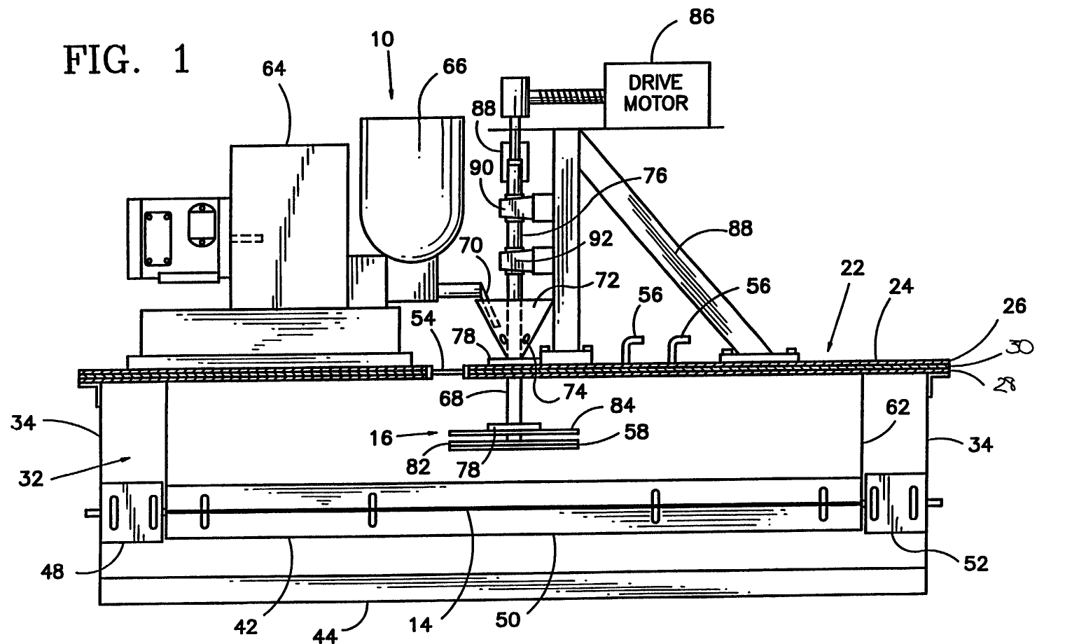

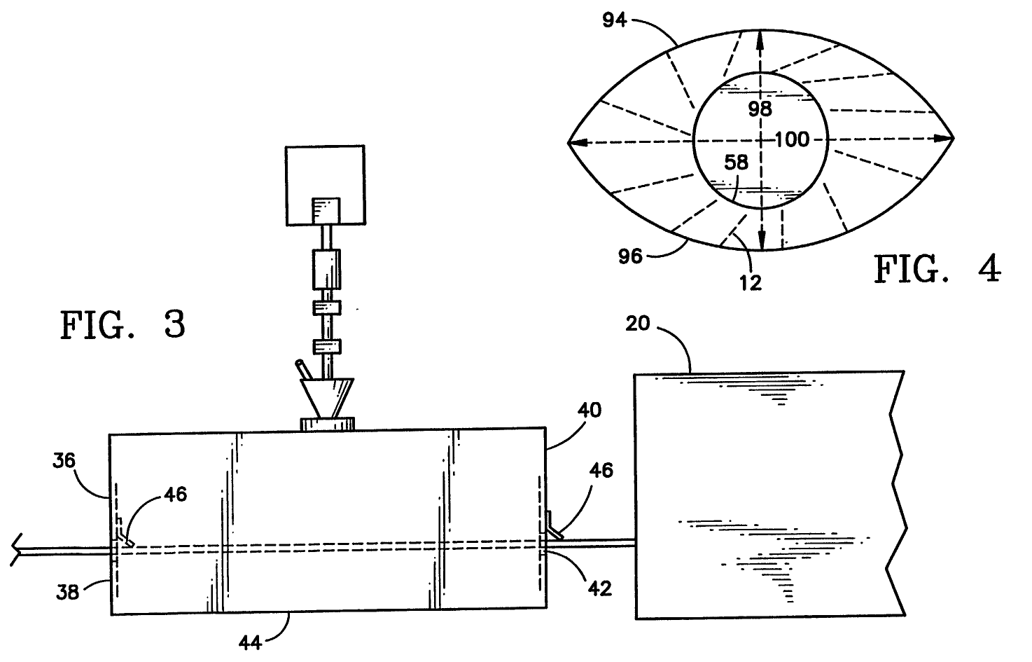

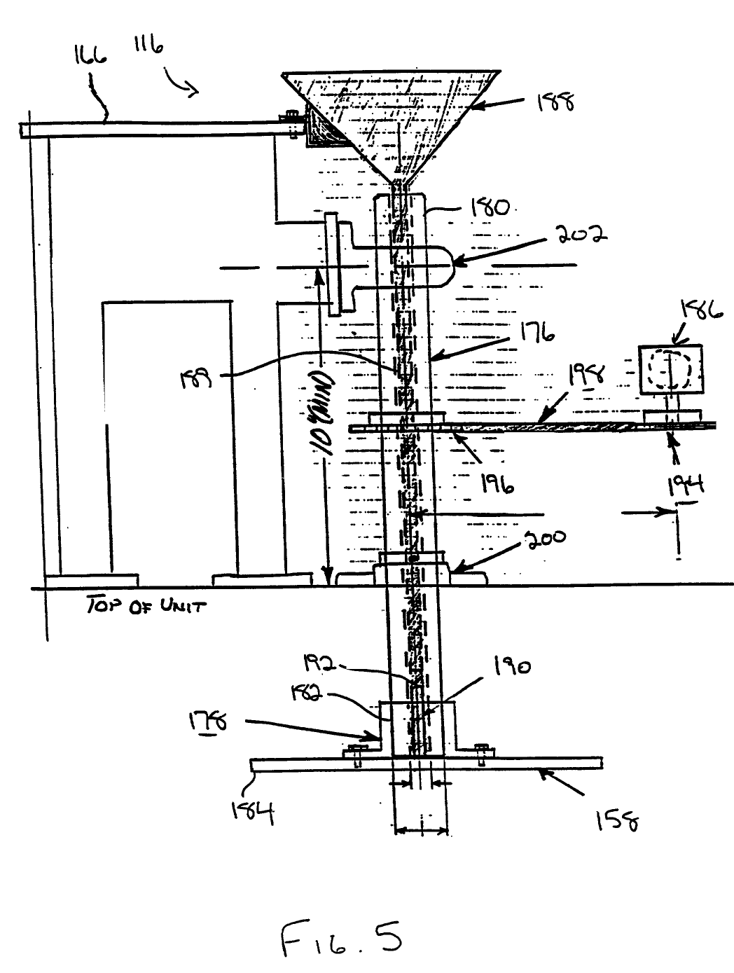

With reference to FIGS. 1, 2, 3 and 4, a distribution assembly 10 for evenly applying solid particles 12 to a moving web 14 is disclosed. In accordance with a preferred embodiment of the present invention, the distribution assembly 10 is particularly adapted for evenly distributing aluminum oxide on a moving paper web used in the manufacture of decorative laminates. As such, the distribution assembly 10 is preferably adapted for inclusion within a paper processing line 18 including, among other things, a furnace 20 for heating the paper to impregnate the aluminum oxide within the web 14.

The distribution assembly 10 is primarily composed of a moving web 14 and a spreading apparatus 16 evenly distributing the solid particles 12 on the moving web 14. The spreading apparatus 16 and moving web 14 are respectively supported by and housed within a distribution framework 22. Specifically, the spreading apparatus 16 is substantially supported by a platform 24 composed of a 0.794 cm board 26, a 1.27 cm board 28 and a 0.635 cm spacer 30 positioned between the 0.794 cm board 26 and the 1.27 cm board 28.

A distribution chamber 32 is formed beneath the platform 24. The distribution chamber 32 defines an enclosure through which the moving web 14 may pass as the particles 12 are distributed thereon. As such, the distribution chamber 32 is defined by side walls 34, an entrance wall 36 with an entrance slit 38 therein for the passage of the moving web 14, an exit wall 40 with an exit slit 42 therein for the passage of the moving web 14, and a bottom surface 44.

In fact, the entrance and exit slits 38, 42 are covered with a clear gate 46, or window, minimizing the required opening for passage of the web 14 therethrough and, thereby, minimizing ambient air turbulence. As shown in FIG. 1, the gates 46 are three part assemblies 48, 50, 52 permitting the ready passage of both 1.22 meter wide webs and 1.53 meter wide webs without modifying the apparatus 10.

Viewing of the particle distribution taking place within the distribution chamber is facilitated by the provision of a sight glass 54 within the platform 24 at strategic locations. The site glass permits the viewing of the various elements lying below the platform 24.

The distribution chamber 32 is further provided with a plurality of air induction ports 56. These ports 56 aid in evenly distributing the air within the distribution chamber 32, or air channel. Specifically, these ports 56 create down draft air flow aiding the particle distribution on the web 14 moving therethrough.

The moving web 14 is drawn below the apparatus 16, and within the distribution chamber 32, by a series of rollers (not shown) positioned at opposite ends of the processing line 18. In fact, and as those skilled in the art will certainly appreciate, the web 14 is supported at various points along its path by physical support members and blown air, depending upon the requirements of the processing taking place. Those skilled in the art will appreciate the various furnace assemblies 20 which may be used in the application of heat subsequent to the spreading of the aluminum oxide for impregnating the aluminum oxide in the paper web being processed.

With regard to the spreading apparatus 16, it is supported above the web 14 in such a way that the solid particles 12 fall on the moving web 14 as the web 14 passes underneath. With this in mind, the spreading apparatus 16 is laterally centered relative to the moving web 14. Referring to FIGS. 1, 2, 3 and 4, the spreading apparatus 16 includes a rotating disk 58 which distributes solid particles 12 outwardly as the solid particles 12 strike the upper surface 60 of the rotating disk 58. The spreading apparatus 16 further includes an eye-shaped baffle 62 positioned about the rotating disk 58 for controlling the distribution of the solid particles 12 leaving the surface of the rotating disk 58. The spreading apparatus 16 also includes a feed assembly 64 positioned above the rotating disk 58 so as to provide a predetermined supply of solid particles 12 to the upper surface 60 of the rotating disk 58.

In use, the feed assembly 64 drops the particles 12 on the rotating disk 58 where they are forced radially outward by the rotating disk 58. The dispersed solid particles 12 contact the baffle 62 and drop onto the web 14 moving below.

The feed assembly 64 includes a twin screw feeder 66 coupled to a feed pipe 68. In accordance with a preferred embodiment of the present invention, the twin screw feeder 66 is a K-Tron Twin Screw Model KV2MVT20, although those skilled in the art will appreciate the many feeders which may be used in accordance with the present invention. The twin screw feeder 66 provides a controlled supply of solid particles to the feed pipe 68 which then directs the solid particles 12 to a predetermined position near the center of the rotating disk 22.

The distal end of the screw feeder 66 is fitted with a drop shoot 70. The drop shoot 70 improves the feed of particles 12 into the collection funnel 72 of the feed pipe 68 by producing a laminar flow of the particles 12, for example, aluminum oxide, into the collection funnel 72. Enhanced feed of the particles 12 through the feed pipe 68 is achieved by positioning two thumbscrews 74 on the drive shaft 76 at a position near the distal end of the collection funnel 72. The thumbscrews 74 provide for equal distribution/agitation of the particles 12 as they pass down the annular space created between the feed pipe 68 and the drive shaft 76.

Feed of the particles 12 is further enhanced by the provision of a set collar 78 attaching the feed tube 68 to the platform 24. The set collar 78 permits adjustment of the feed tube 68 relative to the rotating disk 58. This allows for adjustment of the discharge rate such that it is substantially equivalent to the discharge rate of the screw feeder 66.

With this in mind, the feed pipe 68 is oriented to guide the solid particles 12 to a position substantially adjacent to the center of the rotating disk 58. While the solid particles 12 are directed to the center of the rotating disk 58 in accordance with a preferred embodiment, it is contemplated that the solid particles may be directed at other positions without departing from the spirit of the present invention.

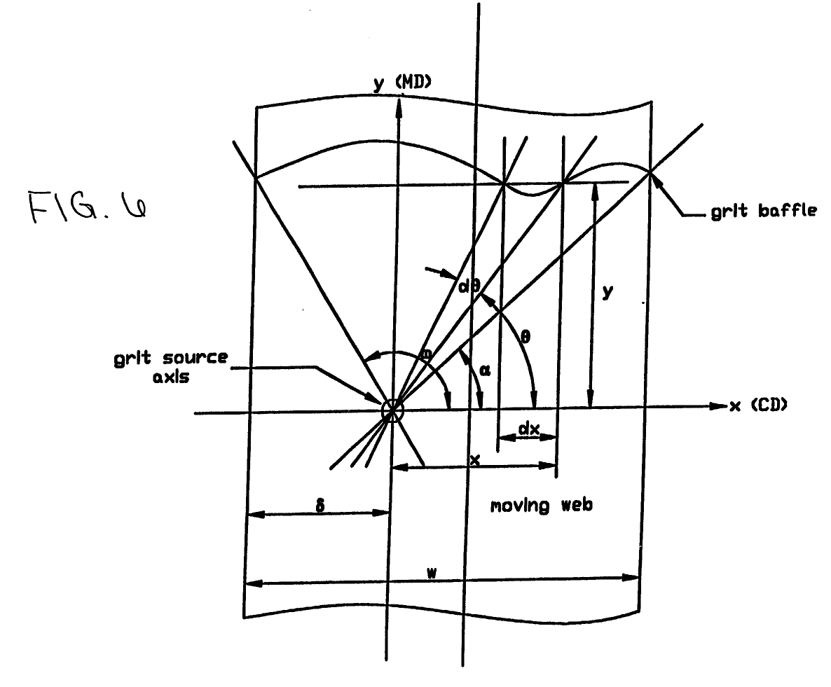

Feed of the solid particles 12 to the center of the rotating disk 58 is achieved by concentrically orienting the feed pipe 68 about a drive shaft 76 supporting and driving the rotating disk 58. Controlled positioning of the drive shaft 76 within the feed pipe 68 is achieved by a flange mount bearing 87 which secures the drive shaft 76 in the center of the feed pipe 68. In this way, the solid particles 12 are fed down the feed pipe 68 adjacent to the drive shaft 76 toward the center of the rotating disk 58. It has been found that the distal end 80 of the feed pipe 68 may be positioned approximately 0.3175 cm above the rotating disk 58 to provide for ideal operation of the present assembly 10. However the exact position of the feed pipe 68 may be varied based upon a variety of operating parameters without departing from the spirit of the present invention. It is further contemplated that the feed of particles to the rotating disk may be achieved using various mechanisms, for example, a hollow drive shaft through which the particles may be poured for uniform application upon the rotating surface of the rotating disk (as shown in FIG. 5).

In accordance with a preferred embodiment of the present invention, the rotating disk 58 is a 40.64 cm diameter, 0.3175 cm thick laminate with a generally smooth surface. The surface contacts the solid particles 12 dropped thereon in a manner providing a uniform distribution about the circumference of the rotating disk 58. Even distribution of the solid particles 12 is further enhanced by the attachment of four pieces of 0.635 cm keystock 82 to the upper surface 60 of the rotating disk 58. Each piece of keystock 82 is oriented to extend radially outwardly from the center of the rotating disk 58. The 0.635 cm keystock 82 is secured to the upper surface 60 of the rotating disk 58 at positions 90 degrees apart from each other to facilitate even distribution of the solid particles 12 as they contact, and are slung outwardly by, the rotating disk 58.

While a preferred construction for the rotating disk is disclosed above, those skilled in the art will appreciate the many variations which may be applied without departing from the spirit of the present invention. For example, although a 40.64 cm disk is disclosed above for use in accordance with a preferred embodiment of the present invention, it is known from prior experimentation that various disk sizes may be used without departing from the spirit of the present invention.

Further improvement in the even distribution of particles 12 by the rotating disk 58 is achieved by the plate 84 positioned above the upper surface 60 of the rotating disk 58. The plate 84 is secured to the drive shaft 76 and rotates with the rotating disk 58.

As mentioned above, the rotating disk 58 is supported by a drive shaft 76. The drive shaft 76 is coupled to a motor 86. The motor 86 rotates the drive shaft 76 and the rotating disk 58 in a controlled manner to create the appropriate force for distributing the solid particles 12 outwardly as they strike the rotating disk 58. The motor 86 is preferably a continuous variable speed electric motor. However, a variety of motors may be used without departing from the spirit of the present invention.

A “love joy” coupling 88 with a rubber element connects the motor 86 to the drive shaft 76 to lessen vibrations undesirably affecting the distribution of particles 12. Both the motor 86 and the drive shaft 76 are supported by a support arm 99. In fact, first and second bearings 90, 92 couple the drive shaft 76 to the support arm 99 in a manner reducing vibrations as the drive shaft 76 rotates to drive the rotating disk 58.

Surrounding the rotating disk 58, and controlling the distribution of solid particles 12 onto the web 14 passing below the rotating disk 58, is a baffle 62. The baffle 62 encloses the space above and is positioned radially outwardly from the rotating disk 58. The shape of the baffle 62 surrounding the perimeter of the rotating disk 58, that is, the portion of the baffle 62 positioned radially outwardly from the rotating disk 58, is specifically shaped to ensure an even distribution of the solid particles 12 on the web 14 passing below the rotating disk 58.

With this in mind, the baffle 62 is generally eye-shaped as it extends about the perimeter of the rotating disk 58. More specifically, the eye-shaped baffle 62 is defined by first and second arcs 94, 96 (or top and bottom halves) which meet at first and second points. The eye-shaped baffle 62 may, therefore, be defined as including a first diameter 98 and a second diameter 100, wherein the first diameter 98 is smaller than the second diameter 100. When positioned above the moving web 14, it is desired that the first diameter 98 be oriented parallel to, or in, the direction in which the moving web 14 is traveling and the second diameter 100 be oriented perpendicular to the, or in the cross web, direction in which the moving web 14 is traveling. When the eye-shaped baffle 62 is properly oriented in this manner, an even distribution of solid particles 12 is dispersed on the web 14 moving below.

In general, and with reference to FIG. 6, the grit baffle is arranged such that the entire flow of grit, or particles, from the grit source impinges on the baffle and is redirected onto the moving web. The grit baffle geometry is such that the deposition of grit onto the web is uniform both along and across the web.

The grit baffle must have a certain geometry to successfully deposit a uniform covering of grit onto the moving web. A generic arrangement appears in top view in FIG. 6. The following assumptions hold.

The grit source produces a uniform radial flow of grit between the angles α and ω as shown in the figure.

All grit emitted by the source impinges on the baffle and falls straight downward onto the moving web.

Consider the infinitesimal baffle segment bound by dx or, equivalently, dθ as shown in FIG. 6. Given the assumption of uniform radial emission by the source, the mass flow rate dm that strikes the baffle and falls onto the web is given by

$$ⅆ \dot{m} = \frac{{\dot{m}}_{T}}{{θ}_{T}} ⅆ θ \qquad ( 0.1 )$$

where m_{T} is the total mass flow rate emitted by the source and θ_{T} is given by

θᵣ=ω−α (0.2)

The objective is to achieve a uniform distribution of grit across the web; i.e.

$$\frac{ⅆ \dot{m}}{ⅆ x} = c o n s t a nt \qquad ( 0.3 )$$

Since all grit m_{T} emitted by the source is redirected onto the web,

$$\frac{ⅆ \dot{m}}{ⅆ x} = \frac{{\dot{m}}_{T}}{w} \qquad ( 0.4 )$$

where w is the web width. Substitution of (0.1) into (0.4) yields the following

$$\frac{ⅆ θ}{ⅆ x} = \frac{{θ}_{T}}{w} \qquad ( 0.5 )$$

Integration of (0.5) with respect to x yields

$$θ = \frac{{θ}_{T}}{w} ( x - w + δ ) + α \qquad ( 0.6 )$$

Here, the following boundary condition was used to evaluate the constant of integration

θ=αat x=w−δ (0.7)

The vertical (MD) baffle coordinate y is related to the horizontal (CD) baffle coordinate x and angle θ through the following expression

$$\frac{y}{x} = tan θ \qquad ( 0.8 )$$

An expression for the required baffle geometry is obtained by combining (0.6) and (0.8)

$$y = f ( x ) = x tan ( \frac{{θ}_{T}}{w} ( x - w + δ ) + α ) \qquad ( 0.9 )$$

Note that the required baffle geometry is independent of the grit mass flow rate mT and the velocity of the moving web.

As an example, consider an arrangement in which the grit source is located on the centerline of the moving web. Further, let the grit source emit over an angle of 180°. The parameter values α, ω and δ are then given by

α=0

ω=η (0.10)

and (0.9) becomes

$$y = x tan ( \frac{π}{w} x - \frac{π}{2} ) \qquad ( 0.11 )$$

A continuous baffle for source emissions over angular extent 360° is obtained by using (0.11) for the ‘upper’ portion of the baffle and then reflecting the result about the x-axis to obtain the ‘bottom’ portion.

In operation, the solid particles 12 are fed by the twin screw feeder 66 into the feed pipe 68 and dropped onto the upper surface 60 at a central position thereof. The rotation of the disk 58 applies radially outward pressure to the particles 12 which are swept along the upper surface 60 of the rotating disk 58 and flung from the outer periphery of the rotating disk 58. The solid particles 12 then contact the baffle 62 and fall downwardly onto the web 14 passing below.

In accordance with preferred embodiments of the present invention it has been found that the rotating disk and the drive shaft rotate at a rate of approximately 400-3000 rpm, more particularly, approximately 1100 rpm. It has been found that extremely high rotation speeds create excessive air currents, which are not good, and very low speeds don't “fling” the aluminum oxide particles off the rotating disk. It is further contemplated that the line speed for the moving web should be approximately 30 to 100 meters per minute. However, we have also run the web at speeds of approximately 4.57 to 12.19 meters per minute, and achieved desirable results. As a result, we anticipate that faster or slower line speeds should be possible within the spirit of the present invention, although we contemplate that faster line speed will predominately be used to optimize manufacturing.

Referring to FIG. 5, and alternate embodiment for the feed assembly 116 is disclosed. The function of the feed assembly 116 is substantially identical to that disclosed above in FIGS. 1, 2 and 3, but the alternate feed assembly 116 incorporates a hollow drive shaft 176 which facilitates the passage of solid particles from the screw feeder 166 to the rotating disk 158. The use of a hollow shaft 176 in accordance with this embodiment allows for the application of solid particles directly to the center of the rotating disk 158, improving the resulting distribution upon the moving web.

The feed assembly 116 includes a hollow shaft 176 having a first end 180 and a second end 182. A stationary funnel 188 with an attached tube 189 is inserted down through the hollow shaft 176. The attached tube 189 extends substantially the entire length of the hollow shaft 176 and ends adjacent the rotating disk 158. The stationary funnel 188 sits atop the hollow shaft 176 for receiving solid particles to be passed through the feed assembly.

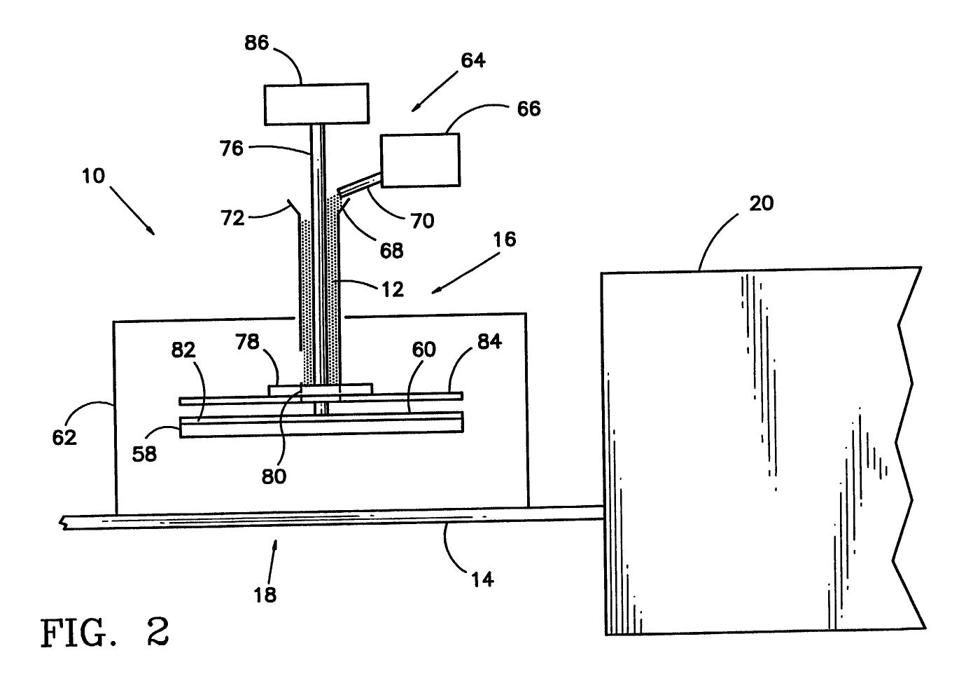

The rotating disk 158 is coupled to the second end 182 of the hollow shaft 176. As with the embodiment disclosed in FIGS. 1 and 2, a plate 184 is positioned above the rotating disk 158. The plate 184 is coupled to the rotating disk 158 such that both the plate 184 and the rotating disk 158 rotate with the hollow shaft 176. Space (for example, 0.635 cm) provided between the edge of the second end 182 and the top surface of the rotating disk 158 for permitting the dispersal of solid particles contacting the rotating disk 158. In accordance with a preferred embodiment of the present invention, a coupling shaft hub 178 secures the second end 182 of the hollow shaft 176 to the plate 184 and ultimately the rotating disk 158. The coupling shaft hub 178 and second end 182 of the hollow shaft 176 are provided with mating keys 190, 192 for proper alignment of the elements.

Rotation of the rotating disk 158 is provided by a gear motor 186 coupled to the central portion of the hollow shaft 176 via pulleys 194, 196 and a drive belt 198. Smooth rotation of the hollow shaft 176 and the rotating disk 158 are ensured by a flange bearing 200 coupled to the platform 124 and a pillow block bearing 202.

The disclosed feed assembly 116 functions in much the same manner as that disclosed with reference to FIGS. 1, 2 and 3. Briefly, solid particles are fed to the stationary funnel 188, through the internal tube 189 of the funnel 188 and down the hollow shaft 176. The solid particles then exit the second end 182 of the hollow shaft 176 where they contact the rotating disk 158 and are “flung” outwardly. In accordance with a preferred construction of the feed assembly disclosed in FIG. 5, the inner diameter of the hollow shaft may be approximately 1.27 cm to ensure free flow of the solid particles therethrough. However, those skilled in the art will appreciate the size of all components may be varied to suit a variety of changes in operating parameters.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A spreading apparatus for evenly distributing solid particles onto a moving web, comprising:
a rotating disk having an upper surface and a lower surface, the upper surface being adapted to distribute solid particles outwardly as the solid particles strike the upper surface of the rotating disk;
a baffle positioned about the rotating disk, the baffle being shaped to evenly distribute solid particles upon the moving web; and
a feed assembly positioned above the rotating disk so as to provide a predetermined supply of solid particles to the upper surface of the rotating disk.

2. The spreading apparatus according to claim 1, wherein keystock is applied to the upper surface of the rotating disk.

3. The spreading apparatus according to claim 2, wherein the feed assembly guides the solid particles to a position adjacent the center of the rotating disk.

4. The spreading apparatus according to claim 1, wherein the baffle is defined by the equation
$$y = x tan ( \frac{π}{w} x - \frac{π}{2} )$$
where w is the width of the web and a continuous baffle for particle emissions over an angular extent 360° is obtained by using the above relationship for an upper portion of the baffle and reflecting results about the x-axis to obtain a bottom portion of the baffle.

5. The spreading apparatus according to claim 1, wherein the baffle is eye-shaped.

6. The spreading apparatus according to claim 5, wherein the baffle includes a first diameter and a second diameter, the second diameter being larger than the first diameter, and wherein the first diameter is oriented in the direction of the moving web and the second diameter is oriented perpendicular to the direction of the moving web.

7. The spreading apparatus according to claim 5, wherein the baffle is defined by the equation
$$y = x tan ( \frac{π}{w} x - \frac{π}{2} )$$
where w is the width of the web and a continuous baffle for particle emissions over an angular extent 360° is obtained by using the above relationship for an upper portion of the baffle and reflecting results about the x-axis to obtain a bottom portion of the baffle.

8. The spreading apparatus according to claim 1, wherein the rotating disk is rotated at approximately 400 to 3000 rpm.

9. The spreading apparatus according to claim 1, wherein the rotating disk is circular.

10. The spreading apparatus according t6 claim 1, wherein the feed assembly guides the solid particles to a position adjacent the center of the rotating disk.

11. A distribution assembly, comprising:
a moving web drawn in a first direction;
a spreading apparatus evenly distributing solid particles onto the moving web, the spreading apparatus including:
a rotating disk having an upper surface and a lower surface, the upper surface being adapted to distribute solid particles outwardly as the solid particles strike the upper surface of the rotating disk;
a baffle positioned about the rotating disk, the baffle including a first diameter and a second diameter wherein the first diameter is smaller than the second diameter, and the first diameter is oriented perpendicular to the first direction in which the web is moving and the second diameter is oriented parallel to the first direction in which the web is moving; and
a feed assembly positioned above the rotating disk so as to provide a predetermined supply of solid particles to the upper surface of the rotating disk.

12. The distribution assembly according to claim 11, wherein sandpaper is applied to the upper surface of the rotating disk.

13. The distribution assembly according to claim 12, wherein the feed assembly guides the solid particles to a position adjacent the center of the rotating disk.

14. The distribution assembly according to claim 11, wherein the baffle is defined by the equation
$$y = x tan ( \frac{π}{w} x - \frac{π}{2} )$$
where w is the width of the web and a continuous baffle for particle emissions over an angular extent 360° is obtained by using the above relationship for an upper portion of the baffle and reflecting results about the x-axis to obtain a bottom portion of the baffle.

15. The distribution assembly according to claim 11, wherein the baffle is eye-shaped.

16. The distribution assembly according to claim 15, wherein the baffle includes a first diameter and a second diameter, the second diameter being larger than the first diameter, and wherein the first diameter is oriented in the direction of the moving web and the second diameter is oriented perpendicular to the direction of the moving web.

17. The distribution assembly according to claim 15, wherein the baffle is defined by the equation
$$y = x tan ( \frac{π}{w} x - \frac{π}{2} )$$
where w is the width of the web and a continuous baffle for particle emissions over an angular extent 360° is obtained by using the above relationship for an upper portion of the baffle and reflecting results about the x-axis to obtain a bottom portion of the baffle.

18. The distribution assembly according to claim 11, wherein the rotating disk is rotated at approximately 400 to 3000 rpm.

19. The distribution assembly according to claim 11, wherein the rotating disk is circular.

20. The distribution assembly according to claim 11, wherein the feed assembly guides the solid particles to a position adjacent the center of the rotating disk.
